(19) United States
(12) Patent Application Publication
(10) Pub. No.: US 2025/0342362 A1
(43) Pub. Date: Nov. 6, 2025

(54) REINFORCEMENT LEARNING-BASED SYSTEMS AND METHODS FOR MESSAGE GENERATION

(71) Applicant: Optum, Inc., Minnetonka, MN (US)

(72) Inventors: Vikas DIXIT, Palwal (IN); Ayan SENGUPTA, Noida (IN); Sudhanshu SHARMA, Basavanagar (IN); Abhishek VERMA, Sugar Land, TX (US); Julie ZHU, Maple Grove, MN (US)

(21) Appl. No.: 18/652,913

(22) Filed: May 2, 2024

(51) Int. Cl. G06N 3/092

(52) U.S. Cl. CPC G06N 3/092

(57) ABSTRACT

Data associated with a user is input into a reinforcement learning model. The reinforcement learning model generates a target message that satisfies a target response level of the user. The target message is transmitted to a computing device for presentation to the user. The reinforcement learning model is trained by: predicting a first message for a first type of user; determining, based on training data, that the first message will not satisfy the target response level; obtaining, using a predefined reward function, rewards based on the determination; and iteratively updating parameters of the reinforcement learning model until a second message is predicted for the first type of user that will satisfy the target response level to maximize the rewards.

### TECHNICAL FIELD

The present disclosure relates generally to the field of data analytics and artificial intelligence, and more particularly, to reinforcement learning-based systems and methods that generate and present target messages to users.

### BACKGROUND

Recommendation systems are implemented to determine an item and/or a manner for presenting such item to a user, such as specific information or content to present to the user. For example, the item can include a product or a service, and the information or content presented aims to persuade the user to purchase the product or enroll or otherwise partake in the service. Conventional recommendation systems often utilize rule-based engines and/or classical recommendation algorithms to make such determinations, each presenting significant limitations.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The techniques of this disclosure improve the state of target message generation by utilizing at least reinforcement machine learning.

In some aspects, the techniques described herein relate to a computer-implemented method for target message generation. An example method includes: inputting, by one or more processors, data associated with a user into a reinforcement learning model; generating, by the one or more processors and via the reinforcement learning model, a target message that satisfies a target response level of the user; and transmitting, by the one or more processors, the target message to a computing device for presentation to the user. The reinforcement learning model is trained by: predicting a first message for a first type of user; determining, based on training data, that the first message will not satisfy the target response level; obtaining, using a predefined reward function, rewards based on the determination; and iteratively updating parameters of the reinforcement learning model until a second message is predicted for the first type of user that will satisfy the target response level to maximize the rewards.

In other aspects, the techniques described herein relate to a system for target message generation. An example system includes one or more processors, and at least one memory storing instructions that, when executed by the one or more processors, cause the one or more processors to perform operations. The operations include: inputting data associated with a user into a reinforcement learning model; generating, via the reinforcement learning model, a target message that satisfies a target response level of the user; and transmitting the target message to a computing device for presentation to the user. The reinforcement learning model is trained by: predicting a first message for a first type of user; determining, based on training data, that the first message will not satisfy the target response level; obtaining, using a predefined reward function, rewards based on the determination; and iteratively updating parameters of the reinforcement learning model until a second message is predicted for the first type of user that will satisfy the target response level to maximize the rewards.

In further aspects, the techniques described herein relate to a non-transitory computer readable medium for target message generation. An example non-transitory computer readable medium stores instructions which, when executed by one or more processors, cause the one or more processors to perform operations. The operations include inputting data associated with a user into a reinforcement learning model; generating, via the reinforcement learning model, a target message that satisfies a target response level of the user; and transmitting the target message to a computing device for presentation to the user. The reinforcement learning model is trained by: predicting a first message for a first type of user; determining, based on training data, that the first message will not satisfy the target response level; obtaining, using a predefined reward function, rewards based on the determination; and iteratively updating parameters of the reinforcement learning model until a second message is predicted for the first type of user that will satisfy the target response level to maximize the rewards.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of an environment for target message generation, according to some embodiments of the disclosure.

FIG. 2 is a flow chart showing an example method for target message generation, according to some embodiments of the disclosure.

FIG. 3 is a system flow diagram depicting the method of FIG. 2, according to some embodiments of the disclosure.

FIG. 4 is conceptual diagram showing an example of a process for pretraining and implementing a pretrained machine learning model, according to some embodiments of the disclosure.

FIG. 5 is a conceptual diagram showing an example of a process for training and implementing a first model of a reinforcement learning (RL) model, according to some embodiments of the disclosure.

FIG. 6 is a conceptual diagram showing an example of a process for training, implementing, and monitoring a second model of the RL model, according to some embodiments of the disclosure.

FIG. 7 is an example target message, according to some embodiments of the disclosure.

FIG. 8 shows an implementation of a computer system that executes techniques presented herein, according to some embodiments of the disclosure.

### DETAILED DESCRIPTION

The present disclosure relates generally to the field of data analytics and artificial intelligence, and more particularly, to reinforcement learning-based systems and methods to generate and present target messages to users.

As briefly mentioned above, conventional recommendation systems implemented to determine an item and/or a manner for presenting such item to a user often utilize rule-based engines and/or classical recommendation algorithms. Rule-based engines rely on predefined, often static, guidelines, which fail to capture the nuanced intricacies of individual user characteristics and preferences, and thus limit an extent of tailoring or personalization enabled. Similarly, tailoring or personalization by the classical recommendation algorithms, such as content and collaborative filtering, is constrained by the need for user interaction data (e.g., interactions of the user or other similar users with previous recommendations output by the system). In some instances, a substantial proportion of users within a potential user population have never interacted with the system, resulting in a cold start problem for the system. Additionally, these conventional systems often rely on raw user features for personalization, which can result in limitations when a feature set for a given user is a sparse feature set.

The present disclosure solves this problem and/or other problems described above or elsewhere in the present disclosure, namely by improving the technical field of machine learning, and the application of machine learning in an unconventional manner to enhance recommendation systems. Specifically, reinforcement learning-based systems and methods are described that generate and present highly tailored content (e.g., in a form of target messages) to the user, even in instances where limited or no user interaction data is available.

For example, based on data associated with the user that is received and provided as input to a reinforcement learning model, a target message that satisfies a target response level of the user is generated by the reinforcement learning model. The reinforcement learning model includes a first model and a second model. To generate the target message, the first model outputs a probability distribution over a plurality of messages (e.g., of varying types or categories) that each message will satisfy the target response level of the user based on the data associated with the user, and selects, as the target message, the message, from the plurality of message types, having a highest probability distribution. In some examples, content of the target message is further customized or tailored to the user, by the first model, based on the data associated with the user.

The target message selected by the first model and the data associated with the user are provided as input to the second model, and the second model outputs a predicted response level of the user to the target message. When the predicted response level meets or exceeds a threshold response level indicative of the target message satisfying the target response level of the user, the target message is provided for presentation to the user. For example, the target message is transmitted to a computing device associated with a representative interacting with the user and/or a computing device associated with the user. The message type of the target message and/or the customized content thereof is aimed at inducing the user to engage with or respond to a recommended item described therein, such as to purchase a product and/or enroll in a service or program.

By harnessing reinforcement learning, the systems and methods described herein overcome the limitations of lack of user interaction data in a cold start scenario. Additionally, by incorporating an external data objective (e.g., via a reinforcement learning policy), the systems are able to consider and integrate more complex rules or requirements into the recommendation process. Example external data objectives include maximization of revenue, reduction of operational costs, or fulfillment of other specific constraints.

Additionally, in some examples, the reinforcement learning model leverages a latent feature representation of a user to facilitate the generation and presentation of highly tailored content to the user. For example, the data associated with the user provided as input to the reinforcement learning system can be the latent feature representation of the user. The latent feature representation of the user is generated by a pretrained machine learning model based on a user data set including a plurality of features associated with the user. By utilizing latent feature representation learning, a more comprehensive understanding of each user's unique characteristics and preferences is developed. Unlike conventional systems that rely on raw user features for personalization, the systems and methods described herein address the limitations associated with sparse features. Advantageously, a tailored latent projection of the user's features is learned, and mapped to a denser subspace. This capability enables discernment of similarities and dissimilarities between users even when working with sparse feature sets.

A robusticity of the system can be further enhanced by leveraging user similarity, via a nearest neighbor model, in instances where the predicted response level of the user to the target message selected by the first model fails to meet or exceed the threshold response level. For example, a similar user having a latent feature representation close in proximity to the latent feature representation of the user is identified using the nearest neighbor model, and a message for which the similar user has previously shown a target response level to (e.g., of a type different from the message type selected by the first model) is provided as the target message for presentation to the user.

The technical improvements and advantages discussed above are not the sole improvements and advantages, and additional technical improvements and advantages will be discussed in the following sections. Further, based on the present disclosure, other technical improvements and advantages will be apparent to one of ordinary skill in the art.

Specific examples included throughout the present disclosure involve determining a target message to present to a user relating to healthcare products and/or services based on a latent feature representation of the user generated from user profile data, including medical data, claims data, and/or demographic data of the user. However, it should be understood that techniques according to this disclosure are adaptable for generating any type of targeted information, where an effectiveness or persuasiveness of that targeted information can be dependent on or specific to multiple features or quantifiable attributes of a user. It should also be understood that the examples above and other examples presented in the present disclosure are illustrative only. The techniques and technologies of this disclosure are adaptable to any suitable activity.

Presented below are various aspects of machine learning techniques that can be adapted for processing data. As will be discussed in more detail below, the machine learning techniques include one or more aspects according to this disclosure, e.g., a particular selection of training data, a particular training process for a machine learning model, operation of the machine learning model in conjunction with particular data, modification of such particular data by the machine learning model, and/or other aspects that are apparent to one of ordinary skill in the art based on this disclosure.

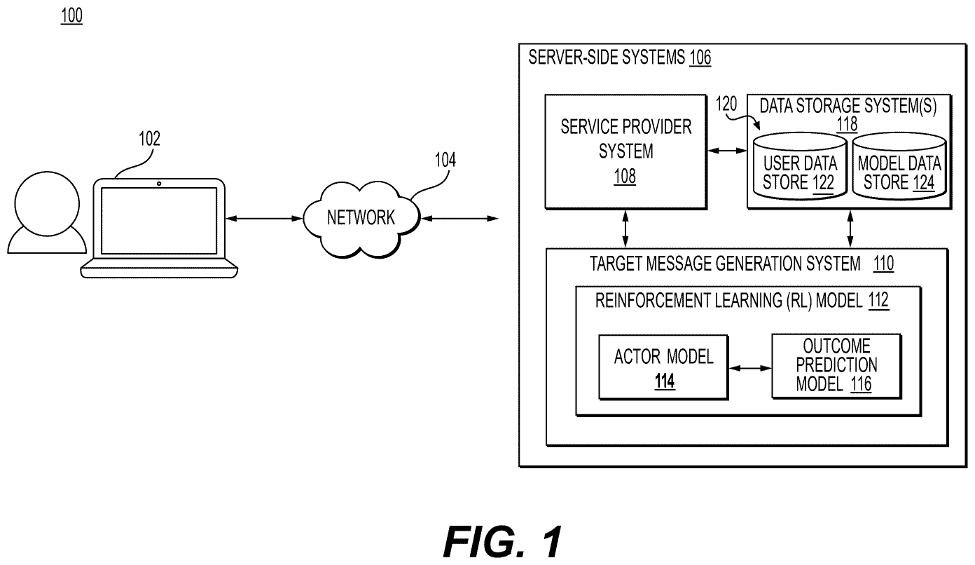

FIG. 1 is a diagram showing an example of an environment 100 for target message generation, according to some embodiments of the disclosure. A device associated a requesting user (e.g., a requesting user device 102) communicates with one or more other components of the environment 100 across a network 104, including one or more server-side systems 106. The server-side systems 106 include a service provider system 108, a target message generation system 110, and/or one or more data storage system(s) 118, among other systems.

In some examples, the service provider system 108, the target message generation system 110, and/or the data storage system(s) 118 are associated with a common entity, e.g., a common payer or health plan provider, such as a health insurance company or the like offering private and/or public health care plans to individuals and/or families, among other health care-adjacent services. In such examples, the service provider system 108, the target message generation system 110, and/or the data storage system(s) 118 can be part of a cloud service computer system (e.g., in a data center). That is, the various systems can be components or subsystems of a larger computer system.

In other examples, one or more of the service provider system 108, the target message generation system 110, and/or the data storage system(s) 118 are separate systems associated with different entities. In such examples, each of the separate systems are communicatively connected to one another over the network 104 (e.g., via an application programming interface (API)). The systems and devices of the environment 100 can communicate in any arrangement. As will be discussed herein, systems and/or devices of the environment 100 communicate in order to perform target message generation.

The requesting user device 102 is configured to enable the requesting user to access and/or interact with other systems in the environment 100. In some examples, the requesting user is a user for which the target message is to be generated. In other examples, the requesting user is a representative or agent of an entity (e.g., a payer or a health plan provider) that is interacting with the user through one or more communication modes to present the target message to the user. The requesting user device 102 is a computer system such as, for example, a desktop computer, a laptop computer, a tablet, a smart cellular phone, a smart watch, or other wearable computer, etc. The requesting user device 102 includes one or more applications, e.g., a program, plugin, browser extension, etc., installed on a memory of the requesting user device 102. The applications can include one or more of system control software, system monitoring software, software development tools, etc.

In some embodiments, at least one of the applications is associated and configured to communicate with one or more of the other components in the environment 100, such as one or more of the server-side systems 106. For example, the at least one application can be executed on the requesting user device 102 to communicate with the target message generation system 110 directly or indirectly via the service provider system 108 over the network 104 to provide a request, and receive a target message responsive to the request for display on the requesting user device 102.

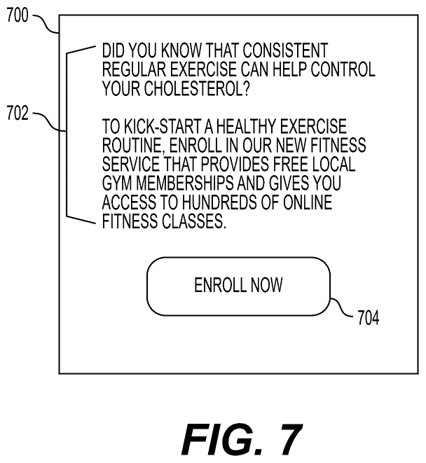

Additionally, one or more components of the requesting user device 102, such as the at least one application, generate, or cause to be generated, one or more user interfaces based on instructions/information stored in the memory, instructions/information received from the other systems in the environment 100, and/or the like and cause the user interfaces to be displayed via a display of the requesting user device 102. The user interfaces can be, e.g., mobile application interfaces or browser user interfaces and include text, input text boxes, selection controls, and/or the like. An example user interface including a target message is shown in FIG. 7. In some examples, the display includes a touch screen or a display with other input systems (e.g., a mouse, keyboard, etc.) to control the functions of the requesting user device 102.

The service provider system 108 includes one or more server devices (or other similar computing devices) for executing services associated with a payer or health plan provider, such as an insurance company or other similar organization. The services can include both user-facing services as well as internal services. One example service provided as a user-interfacing and/or internal service is a target message generation service that can be provided by the payer or a third party described in more detail with reference to the target message generation system 110 below. Another example internal service includes receiving and processing various types of data for a plurality of users having health plans provided by the payer, where user data can be stored in one of the data storage system(s) 118 described below. At least a subset of the user data can be leveraged by the target message generation system 110. Example types of user data used by the target message generation system 110 include medical data, claim data, and/or demographic data.

In some examples, the target message generation system 110 is a system of (e.g., is hosted by) the same payer or health plan provider associated with the service provider system 108. In such examples, the target message generation system 110 can be a sub-system or component of the service provider system 108. In other examples, the target message generation system 110 is a system of (e.g., is hosted by) a third party that provides target message generation services to the payer or health plan provider associated with the service provider system 108.

The target message generation system 110 includes one or more server devices (or other similar computing devices) for performing operations related to target message generation. The target message generation system 110 executes at least a reinforcement learning (RL) model 112 to generate a target message that satisfies a target response for a user. The RL model 112 includes an actor model 114 and an outcome prediction model 116.

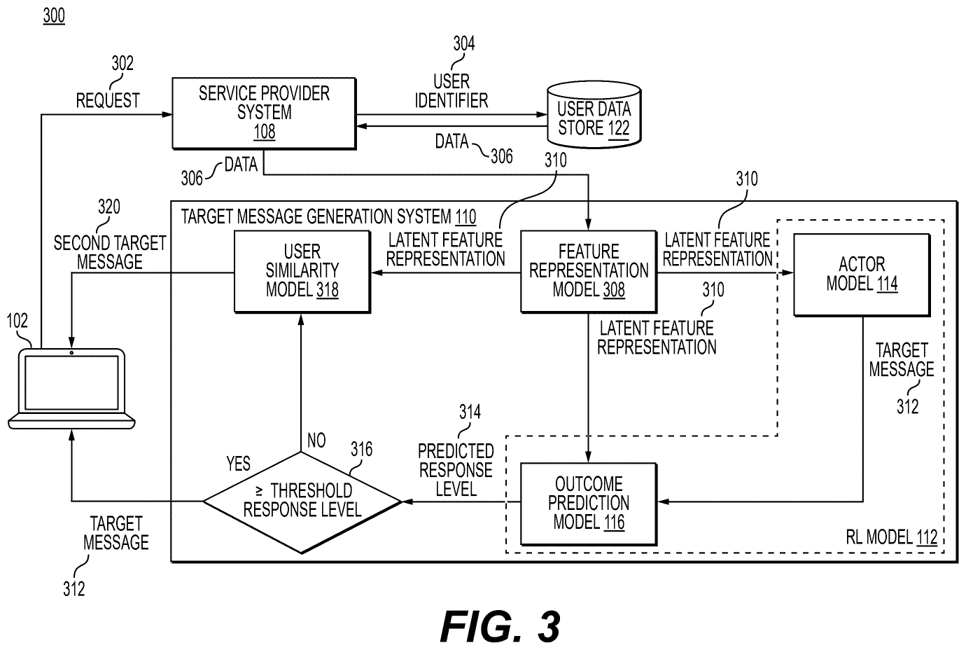

In some examples, and as described in detail with reference to FIG. 3, the target message generation system 110 executes one or more additional models as part of the target message generation process. For example, in some aspects, the target message generation system 110 further leverages latent feature representation learning, and executes a pretrained machine learning model to generate a latent feature representation of the user for input into the RL model 112. Additionally or alternatively, in scenarios where the RL model 112 is unable to generate a target message that satisfies a target response level of the user, the target message generation system 110 further leverages and executes a nearest neighbor model to determine a similar user to the user, and identify a different target message that the similar user has shown the target response level for.

The data storage system(s) 118 each include a server system or computer-readable memory such as a hard drive, flash drive, disk, etc. The data storage system(s) 118 include one or more data stores 120. The data stores 120 include and/or act as a repository or source for various types of data. Examples of the data stores 120 include at least a user data store 122 and a model data store 124. The user data store 122 includes health plan- and/or healthcare-related data associated with each of the plurality of users having health plans provided by the payer. In some examples, the data is collectively referred to as user profile data. Example data types include medical data, claims data, and/or demographic data. The data includes various features that are leveraged by the target message generation system 110 to ultimately generate a target message that is persuasive to and will cause the user to interact or engaged as desired. The model data store 124 includes one or more pretrained or trained models, including at least the RL model 112, that are retrieved and executed by the target message generation system 110 to facilitate target message generation.

In some examples, one of the data storage system(s) 118 maintains each of the data stores 120. In other examples, one or more of the data stores 120 are maintained across two or more different ones of the data storage system(s) 118. One or more of the data storage system(s) 118 can be a system of (e.g., hosted by) the same payer or health plan provider associated with the service provider system 108 and/or target message generation system 110. Additionally or alternatively, one or more of the data storage system(s) 118 are associated with a third party that provides data storage services to the service provider system 108 and/or target message generation system 110.

The network 104 over which the one or more components of the environment 100 communicate includes one or more wired and/or wireless networks, such as a wide area network (“WAN”), a local area network (“LAN”), personal area network (“PAN”), a cellular network (e.g., a 3G network, a 4G network, a 5G network, etc.) or the like. In some embodiments, the network 104 includes the Internet, and information and data provided between various systems occurs online. “Online” means connecting to or accessing source data or information from a location remote from other devices or networks coupled to the Internet. Alternatively, “online” refers to connecting or accessing a network (wired or wireless) via a mobile communications network or device. The Internet is a worldwide system of computer networks-a network of networks in which a party at one computer or other device connected to the network can obtain information from any other computer and communicate with parties of other computers or devices. The requesting user device 102 and one or more of the server-side systems 106 are connected via the network 104, using one or more standard communication protocols. The requesting user device 102 and the one or more of the server-side systems 106 transmit and receive communications from each other across the network 104.

Although depicted as separate components in FIG. 1, it should be understood that a component or portion of a component in the system of the environment 100 is, in some embodiments, integrated with or incorporated into one or more other components. As one example, the target message generation system 110 and/or one or more of the data storage system(s) 118 can be integrated with the service provider system 108 or the like. In some embodiments, operations or aspects of one or more of the components discussed above are distributed amongst one or more other components. Any suitable arrangement and/or integration of the various systems and devices of the environment 100 can be used.

In the following disclosure, various acts are described as performed or executed by a component from FIG. 1, such as the requesting user device 102 or one or more of the server-side systems 106, or components thereof. However, it should be understood that in various aspects, various components of the environment 100 discussed above execute instructions or perform acts including the acts discussed below. An act performed by a device is considered to be performed by a processor, actuator, or the like associated with that device. Further, it should be understood that in various embodiments, various steps can be added, omitted, and/or rearranged in any suitable manner.

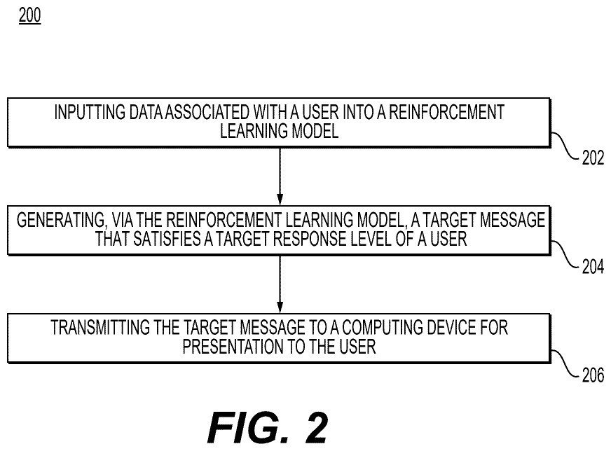

FIG. 2 is a flow chart showing an example method 200 for target message generation, and FIG. 3 is a system flow diagram 300 depicting the method 200 of FIG. 2, according to some embodiments of the disclosure. In some examples, the method 200 is performed by the target message generation system 110.

Referring concurrently to FIGS. 2 and 3, at step 202, the method 200 includes inputting data associated with a user into the RL model 112. As one illustrative example, a request 302 to generate a target message for a user is received at the service provider system 108 from the requesting user device 102. The request 302 includes a user identifier 304 of the user for whom the target message is to be generated. The service provider system 108 queries the user data store 122 using the user identifier 304 to obtain data 306 associated with the user. The data 306 can include various types of data associated with the user, such as medical data, claims data, and/or demographic data. The data 306 is provided by the service provider system 108 to the target message generation system 110 for inputting into the RL model 112. In other examples, the service provider system 108 provides the request 302 to the target message generation system 110 or the target message generation system 110 receives the request 302 directly from the requesting user device 102. In such examples, the target message generation system 110 queries the user data store 122 to obtain the data 306.

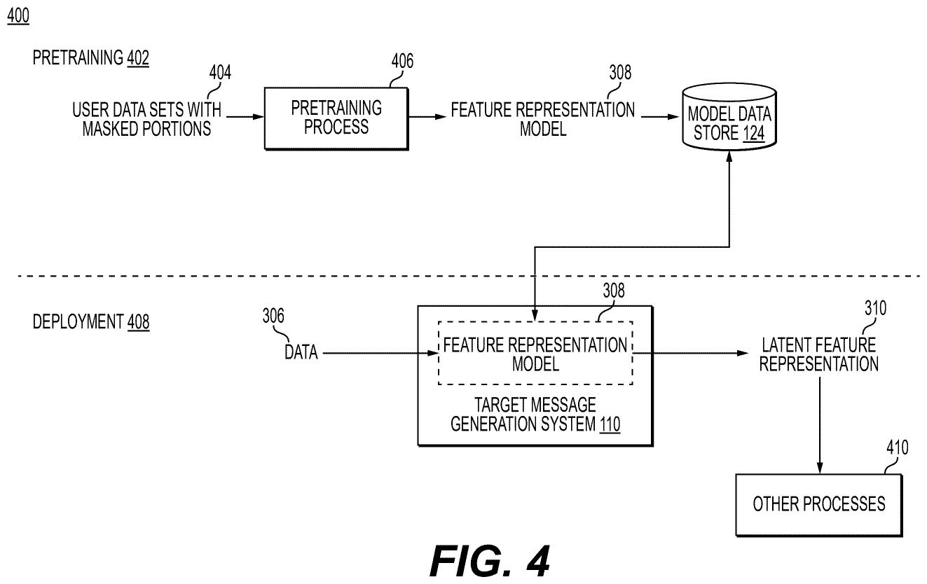

In some examples, the data 306 associated with the user is input to the RL model 112. In other examples, and as shown in FIG. 3, the data 306 is further processed prior to being input to the RL model 112. For example, and as described in more detail with reference to FIG. 4, the target message generation system 110 includes a pretrained feature representation model 308 that generates a latent feature representation 310 of the user based on the data 306 input to the feature representation model 308. The latent feature representation 310 is then input to the RL model 112 for processing.

At step 204, the method 200 includes generating, via the RL model 112, a target message 312 that satisfies a target response level. A response level generally is associated with a persuadability of the target message 312, which refers to a likelihood of the user performing a certain action or interacting in a certain way based on or in response to the target message 312. The target response level is a desired interaction or engagement of the user. For example, if the target message is intending to persuade the user to enroll in a healthcare-related service, such as an exercise program, a target message that satisfies the target response level is one that is likely to persuade the user to enroll in the service.

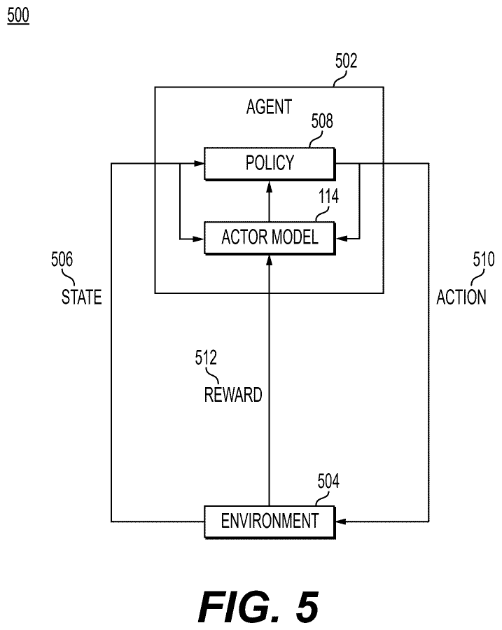

As described above with reference to FIG. 1, the RL model 112 includes the actor model 114 and the outcome prediction model 116. Initially, the latent feature representation 310 is provided as input to the actor model 114. Additionally, a plurality of messages (e.g., of varying types or categories) that are currently available to be selected as a target message are provided to the actor model 114 as input. Example message types associated with healthcare-related services can include messages directed toward lifestyle habits, preventative care, hospital avoidance, physical exam, social wellness, and/or emotional wellness. As described in more detail with reference to FIG. 5, the actor model 114 processes the latent feature representation 310 to output a probability distribution over the plurality of messages that each message will satisfy the target response level of the user. The actor model 114 selects, as the target message 312, a message, from the plurality of message types, having a highest probability distribution. For brevity and clarity, selection of one message is described. However, in other examples, two or more messages, from the plurality of messages, having the highest probability distributions can be selected. In some examples, the actor model 114 also generates custom content for the given message type selected as the target message 312 based on the latent feature representation 310.

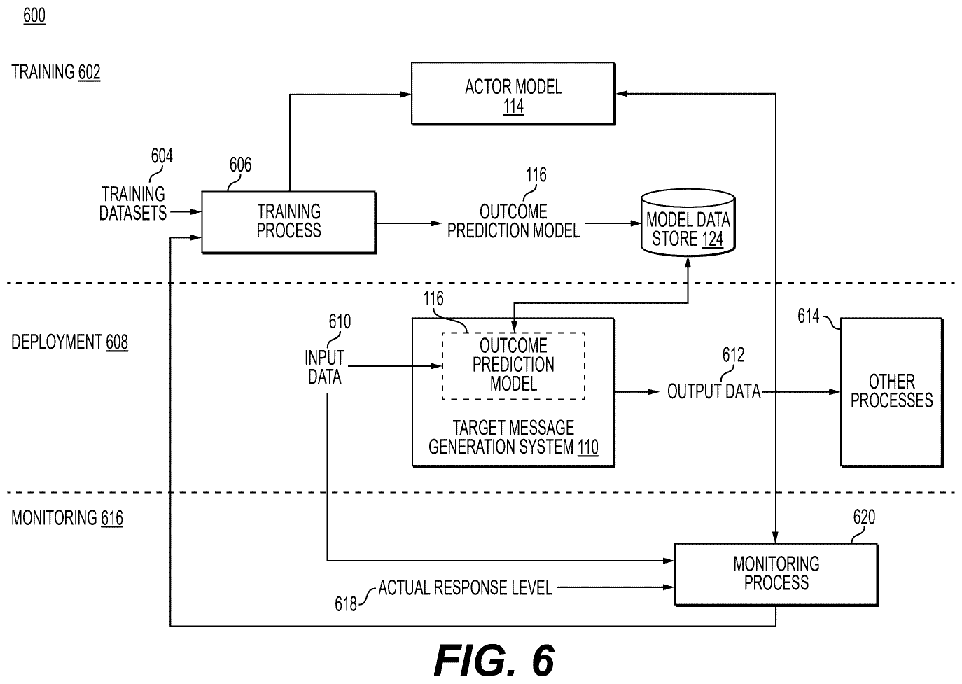

The target message 312 and the latent feature representation 310 are then provided as input data to the outcome prediction model 116. In some examples, the actor model 114 provides the target message 312, while the feature representation model 308 provides the latent feature representation 310 to the outcome prediction model 116, as shown. In other examples, the actor model 114 provides both of the target message 312 and the latent feature representation 310 to the outcome prediction model 116. As described in more detail with reference to FIG. 6, the outcome prediction model 116 processes the target message 312 and the latent feature representation 310 to output a predicted response level 314 of the user to the target message 312.

In some examples, at a decision 316, a determination of whether the predicted response level 314 meets or exceeds a threshold response level is made. The predicted response level 314 meeting or exceeding the threshold response level is indicative of the target message 312 satisfying the target response level of the user. Therefore, the method 200 proceeds to step 206.

At step 206, the method 200 includes transmitting the target message 312 to a computing device (e.g., the requesting user device 102) for presentation to the user. In examples where the requesting user is the user for which the target message 312 is to be generated, the target message 312 can be transmitted as an interactive application notification, email, text message, or other similar communication to the requesting user device 102. In other examples, where the requesting user is a representative or agent, the target message 312 can be provided as a script or content, for example, to the requesting user device 102. The representative or agent may then utilize that script as they are talking to the user over the phone and/or may insert the content into electronic or physical communications to send to the user.

In other examples, when at decision 316, a determination is made that the predicted response level 314 does not meet or exceed the threshold response level, and thus the target message 312 (e.g., a first target message) does not satisfy the target response level of the user, a second target message 320 is generated and transmitted to the requesting user device 102 for presentation to the user. For example, the target message generation system 110 can further include a user similarity model 318. In some examples, the user similarity model 318 employs a nearest neighbor approach (e.g., is a nearest neighbor model). For example, the user similarity model 318 calculates distances between latent feature representations of users projected in a representation space to establish similarity metrics between the users.

To generate the second target message 320, the latent feature representation 310 of the user is provided as input to the user similarity model 318 to identify a similar user to the user. For example, a similar user having a latent feature representation close in proximity to the latent feature representation 310 of the user is identified by the user similarity model 318. A message type for which the identified similar user has shown a target response level is determined, and the second target message 320 of the determined message type is generated. The message type of the second target message 320 is different from the message type of the target message 312.

Accordingly, certain aspects of this disclosure include methods for target message generation. The method 200 described above is provided merely as an example, and can include additional, fewer, different, or differently arranged steps than depicted in FIG. 2, respectively.

FIG. 4 is a conceptual diagram 400 showing an example of a process for pretraining and implementing a pretrained machine learning model (e.g., the feature representation model 308), according to some embodiments of the disclosure. The process includes pretraining 402 and deployment 408. The process is provided merely as an example, and can include additional, fewer, different, or differently arranged aspects than depicted in FIG. 4. In some embodiments, the target message generation system 110 performs both pretraining 402 and deployment 408. In other embodiments, a system or device other than the target message generation system 110 performs the pretraining 402 of the feature representation model 308. The pretrained feature representation model 308 is then provided to the target message generation system 110 for storage in the model data store 124 and subsequent deployment 408.

During the pretraining 402, a plurality of data sets 404 associated with a plurality of users are received (e.g., from the user data store 122). The plurality of data sets include user profile data of varying data types, such as medical data, claims data, and/or demographic data of the user. Within each of the data sets, at least a portion of the data types are masked for use in pretraining the feature representation model 308 via a pretraining process 406.

For example, the pretraining process 406 includes training the feature representation model 308 to learn complex, latent (or hidden) feature representations from the data sets 404. Example features included in the data sets 404 from which the representations are learned, include, but are not limited to, a diabetes indicator, breast cancer screening, colorectal cancer screening, cholesterol screening, body mass index (BMI) assessment, controlling high blood pleasure, cholesterol values number of claims, age, and/or income. In some examples, the feature representation model 308 is a self-supervised model (e.g., a TabNet model). To begin the pretraining process 406, the feature representation model 308 is initialized with random weights. For self-supervised learning, a portion of data within the data sets 404 is masked. For example, cholesterol values are masked. The feature representation model 308 is trained to predict the masked cholesterol values based on the remaining features in the data sets 404. This process is iteratively repeated as different portions of the data within the data sets 404 are masked.

In some examples, the feature representation model 308 includes an encoder-decoder architecture and an attention mechanism that, in combination, enable the feature representation model 308 to learn complex representations from the data sets 404. The attention mechanism dynamically adjusts or modulates an importance (e.g., significance) or attention assigned to each feature throughout the training process. The attention mechanism learns to emphasize certain features for predicting the masked values accurately. For example, in determining which features to emphasize, the feature representation model 308 relies on learned attention weights. The learned attention weights signify the relative importance assigned to different features, guiding the feature representation model 308 to focus on the most influential aspects of the data sets 404. The encoder of the encoder-decoder architecture captures essential features from each of the data sets 404 provided as input. The decoder of the encoder-decoder architecture reconstructs the masked values, emphasizing the learned representations. During backpropagation, weights of the feature representation model 308 are updated to minimize the difference between the predicted and actual masked values. Resultantly, the feature representation model 308 learns to generate latent features that encapsulate important information about the user by capturing patterns and relationships within the data sets 404.

To provide a non-liming, illustrative example, a data set of a user (e.g., one of data sets 404) includes two features: age and cholesterol. The encoder processes the data set to obtain a hidden representation, where the hidden representation has two dimensions (e.g., one for each of the age and cholesterol features). The attention mechanism determines attention scores for the two features based on the hidden representation, which is based, at least in part, on a weighting of the features. The attention mechanism then obtains a feature map by summing the weighted features. The decoder uses the feature map to reconstruct the features, and a loss function is applied to determine a loss based on the reconstructed features and the actual masked values. Parameters of the feature representation model 308 are updated through backpropagation to minimize the loss.

The attention mechanism, dynamically adjusts the importance of the age feature and the cholesterol feature based on their contribution to the hidden representation. For example, if cholesterol has more significance in predicting masked values, the attention score for cholesterol will be higher than the attention score for age. The decoder then utilizes the feature map to reconstruct the masked values, and the feature representation model 308 learns to prioritize the features that are more relevant for accurate reconstruction.

For deployment 408, the pretrained feature representation model 308 is retrieved from the model data store 124 and executed by the target message generation system 110. The data 306 associated with the user (e.g., obtained from the user data store 122 as described with reference to FIG. 3), is provided as input and processed to output the latent feature representation 310 of the user. The latent feature representation 310 is then transmitted to one or more other components of the environment 100, such as the RL model 112 and/or the user similarity model 318 for use in one or more other processes 410.

While FIG. 4 describes the feature representation model 308 as a self-supervised, pretrained model, in other examples, the feature representation model 308 can be an autoencoder model.

FIG. 5 is a conceptual diagram 500 showing an example of a process for training and implementing a first model (e.g., the actor model 114) of the RL model 112, according to some embodiments of the disclosure. The process is provided merely as an example, and can include additional, fewer, different, or differently arranged aspects than depicted in FIG. 5. In some embodiments, the target message generation system 110 performs an entirety of the process. In other embodiments, a system or device other than the target message generation system 110 performs at least a portion of the process (e.g., trains the actor model 114 and provides to the target message generation system 110).

The process is a reinforcement learning process that includes defining an agent 502 and an environment 504 that the agent is interacting with. For example, the agent 502 includes the actor model 114 and a policy 508 on which the actor model 114 is built. The policy 508, for example, is designed to maximize a persuadability of a target message to a user that is output by the actor model 114 to cause the user to interact with or engage in a desired manner (e.g., to enroll in a healthcare-related service presented as part of the target message content). The environment 504 includes at least the feature representation model 308 and the outcome prediction model 116. The agent 502 determines and performs an action 510 based on a state 506 of the environment 504.

The state 506 includes a plurality of messages currently available. The messages are of varying types or categories associated with a content included therein. Example message types for healthcare-related services can include messages directed toward lifestyle habits, preventative care, hospital avoidance, physical exam, social wellness, and/or emotional wellness. The state 506 also includes data associated with a user (e.g., similar to the data 306). In some examples, the state 506 specifically includes a latent feature representation of the user generated by the feature representation model 308 (e.g., similar to the latent feature representation 310). The action 510 includes a predicted target message for the user. The predicted target message includes a message type most likely to persuade the user to interact or engage in a desired manner (e.g., to enroll in a service presented as part of the content the target message). The content of the target message can be further customized based on the latent feature representation.

In some examples, the actor model 114 is a neural network. To train the actor model 114 to determine the action 510, the actor model 114 predicts a probability distribution over the plurality of messages given the latent feature representation of the user. A Bernoulli distribution is used to sample messages based on these probabilities. Sampling from the Bernoulli distribution introduces stochasticity to enable exploration of different message (e.g., different message types) during training.

The actor model 114 interacts with the user via the sampled message, and the agent 502 obtains a reward 512 based on a response level of the user. For example, the agent 502 receives feedback from the environment 504 to obtain the reward 512. Example response level feedback on which the reward 512 is at least partially based can include a predicted response level of the user to the predicted message output as the action 510, as determined by the outcome prediction model 116. Additionally or alternatively, if data is available indicating an actual response level of the user to the predicted message, the feedback on which the reward 512 is at least partially based can include the actual response level of the user.

For example, in some instances, the user is a first type of user. The first type of user is a cold-start user that has not previously interacted with the target message generation system 110 (e.g., has never has received and interacted with a target message) and/or the service provider system 108 in general (e.g., is a new member), and thus little to no data is available on the user for the target message generation system 110 to glean from. Nonetheless, by implementing the reinforcement learning process that leverages a predicted response level of the user determined by the outcome prediction model 116, the target message generation system 110 can overcome the cold start issue, and ultimately train the actor model 114 to accurately predict the message for the first type of user. In other instances, the user is a second type of user. The second type of user has previously interacted with the target message generation system 110. For example, the second type of user has received the message predicted by the actor model 114, and the actual response level of the user to that message has been monitored and recorded (e.g., for use as a label as described in more detail with reference to FIG. 6).

The reward 512 can be positive or negative based on an outcome of the action 510 (e.g., based on the predicted and/or actual response level of the user). For example, positive rewards are provided for desired outcomes, and negative rewards are provided for undesired outcome. Additionally, the reward 512 can be a predefined reward function that is customized or tailored based on rules. As one example, the predefined reward function varies a value of the reward 512 based on rules associated with the characteristics or status of the user. To provide an illustrative example, when the target response level is user enrollment in a service offered by the healthcare provider, the reward 512 is a positive value if the user enrolls or maintains enrollment, while the reward 512 is a negative value if the user continues to be unenrolled or was previously enrolled and now unenrolls. However, the particular positive or negative value varies based on a current status of the user with relation to the healthcare plan (e.g., existing member or new member) and with relation to the particular service (e.g., enrolled or unenrolled). For example, a highest positive value is associated with an existing member that was previously unenrolled and now enrolls, an intermediate positive value is associated with a new member that enrolls, and a lower positive value is associated with an existing member that was already enrolled and maintains enrollment. As another example, a highest negative value is associated with an existing member that was previously enrolled and now unenrolls, an intermediate negative value is associated with a new member that does not enroll, and a lowest negative value is associated with an existing member that was previously unenrolled and remains unenrolled.

Parameters of the actor model 114 are updated through backpropagation to minimize a loss, and ultimately maximize expected rewards. In other words, parameters of the actor model 114 are adjusted to increase a likelihood that the action 510 output by the actor model 114 based on the state 506 of the environment 504 will lead to rewards 512 of higher, positive values. Additionally, the policy 508 is updated to maximize the expected rewards.

FIG. 6 is a conceptual diagram 600 showing an example of a process for training, using, and monitoring a second model (e.g., the outcome prediction model 116) of the RL model 112, according to some embodiments of the disclosure. The process is provided merely as an example, and can include additional, fewer, different, or differently arranged aspects than depicted in FIG. 6. In some embodiments, the target message generation system 110 performs each of training 602, deployment 608, and monitoring 616 processes. In other embodiments, a system or device other than the target message generation system 110 performs the training 602 of the outcome prediction model 116. The trained outcome prediction model 116 is then provided to the target message generation system 110 for deployment 608. Additionally or alternatively, a same or different system or device other than the target message generation system 110 performs the monitoring 616, where the outcome prediction model 116 is updated and/or re-trained based on the monitoring to improve an accuracy of the outcome prediction model 116.

In some examples, the outcome prediction model 116 is a supervised machine learning model, and more specifically a neural network. During training 602, a plurality of training datasets 604 associated with a plurality of users are received. The users are users of a second type that have previously interacted with the target message generation system 110. For example, each training data set of the training datasets 604 includes a known message (e.g., of a given message type) that was previously presented to a user, a known label indicating a response level of the user to the known message, and data associated with the user (e.g., similar to the data 306 and/or the latent feature representation 310 generated from the data 306). The data associated with the user is associated with a time (e.g., includes available data for the user up until the time) that the known message was generated.

At least a portion of the training datasets 604 are provided as inputs to a training process 606 to generate (e.g., build) the outcome prediction model 116 Generally, a model includes a set of variables, e.g., nodes, neurons, filters, etc., that are tuned, e.g., weighted or biased, to different values via the application of the training datasets 604.

The training process 606 employs supervised learning processes to train the outcome prediction model 116. When supervised learning processes are employed, labels or scores, such as the above-described known label indicating a response level of the user to the known message, facilitate the learning process by providing a ground truth. Training proceeds by feeding the known message and the data associated with the user included in one of the training datasets 604 (e.g., a sample) into the model, the model having variables set at initialized values, e.g., at random, based on Gaussian noise, a pretrained model, or the like. The model outputs a predicted response level of the user to the known message for the sample.

The output is compared with the corresponding label for the training dataset 604 (e.g., the ground truth) that indicates the known response level of the user to the known message. This process is repeated for a plurality of samples (e.g., at least the portion of the plurality of the training datasets 604) at least until a determined loss or error is below a predefined threshold. In some examples, the other portions of the training datasets 604 that are withheld are then used to further validate or test the outcome prediction model 116. While the outcome prediction model 116 is described as a supervised model herein, in other examples, unsupervised, semi-supervised, and/or reinforcement learning processes can be employed to train the outcome prediction model 116.

In some examples, data from the training process 606, such as predicted response levels and/or the known labels indicating response levels associated with the known messages can be provided for use in training the actor model 114. In some examples, and described in detail above with reference to FIG. 5, a portion of the data from the training process 606 is used to obtain rewards 512. For example, if based on the data from the training process 606, a determination is made that a first message for a user predicted by the actor model 114 will not satisfy the target response level, rewards 512 are obtained based on the determination using the predefined reward function, and parameters of the RL model 112, and particularly the actor model 114, are iteratively updated until a second message is predicted that will satisfy the target response level to maximize the rewards 512. Additionally, once trained, the outcome prediction model 116 is stored for subsequent deployment (e.g., in the model data store 124).

During deployment 608, the outcome prediction model 116 is retrieved from the model data store 124 and executed by the target message generation system 110 to e.g., perform at least portions of the step 204 of the method 200 described above with reference to FIGS. 2 and 3. Input data 610, including the target message 312 for the user generated by the actor model 114 and the latent feature representation 310 of the user generated by the feature representation model 308, is provided to the outcome prediction model 116. The outcome prediction model 116 then outputs the predicted response level 314, as output data 612, based on the input data 610.

In some examples, the output data 612 is provided to one or more other processes 614, such as the thresholding process to determine whether the predicted response level 314 meets a threshold response level. Whether or not the predicted response level 314 meets the threshold response level indicates whether the target message 312 satisfies the target response level. Additionally, the output data 612 can be provided for use in training the actor model 114.

During the monitoring 616 of the outcome prediction model 116, an actual response level 618 of the user to the target message 312 is collected as feedback. For example, as part a monitoring process 620, the actual response level 618 is analyzed along with the input data 610 (e.g., the target message 312 and latent feature representation 310) to determine an accuracy of the predicted response level 314 provided as the output data 612. The outcome prediction model 116 can then be re-trained or updated based on the analysis of the feedback performed during the monitoring process 620. For example, the input data 610 and the actual response level 618 are provided as a new training data set (e.g., the actual response level 618 serving as the known label) to retrain the outcome prediction model 116 using the training process 606. For example, the value of one or more variables of the outcome prediction model 116 are adjusted. In some examples, the outcome prediction model 116 is retrained after a predefined number of new training data sets have been received. The retrained outcome prediction model 116 can then be stored for subsequent deployment (e.g., in the model data store 124). In some examples, the actual response level 618 can also be provided for use in training the actor model 114 (e.g., for obtaining the rewards 512 and adjusting parameters of the actor model 114 to maximize).

FIG. 7 is an example target message 702, according to some embodiments of the disclosure. When the requesting user is the user for whom the target message 312 is to be generated (e.g., the requesting user device 102 is associated with the user), the target message 702 is provided for display on a screen or user interface 700 of the requesting user device 102. In some examples, the target message 702 is provided in a form of an application notification, email, text message, or other similar communication.

To provide an illustrative example, based on data associated with the user indicating the user has a diabetes indicator and high cholesterol, the RL model 112 generates a lifestyle habits message type having custom content aimed at mitigating the high cholesterol of the user as the target message 702 to persuade the user to enroll in a physical wellness service. As shown, an interactive control element 704 can be displayed along with the target message 702 on the user interface 700 to facilitate the desired user interaction or engagement. For example, upon selection of the interactive control element 704, the requesting user device 102 can launch an application (e.g., web or local) associated with the service provider that enables the user to enroll in the physical wellness service.

The user interface 700 described above is provided merely as an example, and may include additional, fewer, different, or differently arranged information and/or interactive control elements than depicted in FIG. 7.

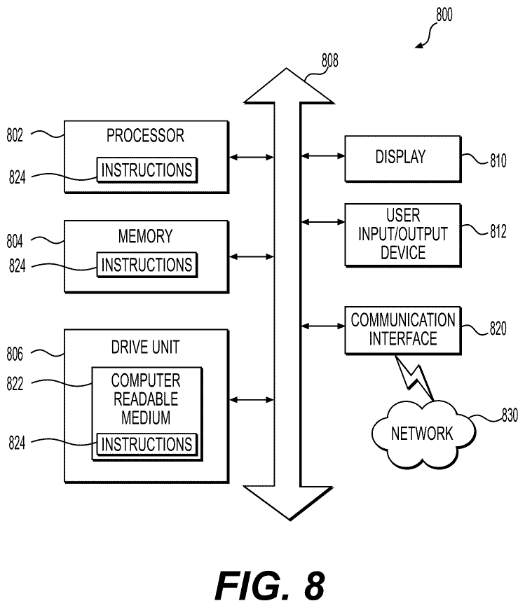

FIG. 8 shows an implementation of a computer system 800 that executes techniques presented herein, according to some embodiments of the disclosure. The computer system 800 can include a set of instructions that can be executed to cause the computer system 800 to perform any one or more of the methods or computer-based functions disclosed herein. The computer system 800 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 800 operates in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 800 can be implemented using electronic devices that provide voice, video, or data communication. Further, while the computer system 800 is illustrated as a single system, the term “system” shall also be taken to include any collection of systems or sub-systems that individually or jointly execute a set, or multiple sets, of instructions to perform one or more computer functions.

As illustrated in FIG. 8, the computer system 800 includes a processor 802, e.g., a central processing unit (CPU), a graphics processing unit (GPU), or both. The processor 802 can be a component in a variety of systems. For example, the processor 802 is part of a standard personal computer or a workstation. The processor 802 is one or more processors, digital signal processors, application specific integrated circuits, field programmable gate arrays, servers, networks, digital circuits, analog circuits, combinations thereof, or other now known or later developed devices for analyzing and processing data. The processor 802 implements a software program, such as code generated manually (e.g., programmed).

The computer system 800 includes a memory 804 that can communicate via a bus 808. The memory 804 is a main memory, a static memory, or a dynamic memory. The memory 804 includes, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, and the like. In one implementation, the memory 804 includes a cache or random-access memory for the processor 802. In alternative implementations, the memory 804 is separate from the processor 802, such as a cache memory of a processor, the system memory, or other memory. The memory 804 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 804 is operable to store instructions executable by the processor 802. The functions, acts or tasks illustrated in the figures or described herein are performed by the processor 802 executing the instructions stored in the memory 804. The functions, acts or tasks are independent of the particular type of instructions set, storage media, processor or processing strategy and are performed by software, hardware, integrated circuits, firm-ware, micro-code and the like, operating alone or in combination. Likewise, processing strategies can include multiprocessing, multitasking, parallel processing, and the like.

As shown, the computer system 800 further included a display 810, such as a liquid crystal display (LCD), an organic light emitting diode (OLED), a flat panel display, a solid-state display, a cathode ray tube (CRT), a projector, a printer or other now known or later developed display device for outputting determined information. The display 810 acts as an interface for the user to see the functioning of the processor 802, or specifically as an interface with the software stored in the memory 804 or in a drive unit 806.

Additionally or alternatively, the computer system 800 includes an input/output device 812 configured to allow a user to interact with any of the components of the computer system 800. The input/output device 812 is a number pad, a keyboard, or a cursor control device, such as a mouse, or a joystick, touch screen display, remote control, or any other device operative to interact with the computer system 800.

The computer system 800 also or alternatively includes the drive unit 806 implemented as a disk or optical drive. The drive unit 806 includes a computer-readable medium 822 in which one or more sets of instructions 824, e.g., software, can be embedded. Further, the sets of instructions 824 embody one or more of the methods or logic as described herein. The instructions 824 reside completely or partially within the memory 804 and/or within the processor 802 during execution by the computer system 800. The memory 804 and the processor 802 can also include computer-readable media as discussed above.

In some systems, the computer-readable medium 822 includes the sets of instructions 824 or receives and executes the sets of instructions 824 responsive to a propagated signal so that a device connected to a network 830 can communicate voice, video, audio, images, or any other data over the network 830. Further, the sets of instructions 824 are transmitted or received over the network 830 via a communication port or interface 820, and/or using the bus 808. The communication port or interface 820 is a part of the processor 802 or is a separate component. The communication port or interface 820 is created in software or is a physical connection in hardware. The communication port or interface 820 are configured to connect with the network 830, external media, the display 810, or any other components in the computer system 800, or combinations thereof. The connection with the network 830 is a physical connection, such as a wired Ethernet connection or is established wirelessly as discussed below. Likewise, the additional connections with other components of the computer system 800 are physical connections or are established wirelessly. The network 830 is alternatively directly connected to the bus 808.

While the computer-readable medium 822 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that cause a computer system to perform any one or more of the methods or operations disclosed herein. In some examples, the computer-readable medium 822 is non-transitory, and is tangible.

The computer-readable medium 822 can include a solid-state memory such as a memory card or other package that houses one or more non-volatile read-only memories. The computer-readable medium 822 can be a random-access memory or other volatile re-writable memory. Additionally or alternatively, the computer-readable medium 822 can include a magneto-optical or optical medium, such as a disk or tapes or other storage device to capture carrier wave signals such as a signal communicated over a transmission medium. A digital file attachment to an e-mail or other self-contained information archive or set of archives are considered a distribution medium that is a tangible storage medium. Accordingly, the disclosure is considered to include any one or more of a computer-readable medium or a distribution medium and other equivalents and successor media, in which data or instructions are storable.

In an alternative implementation, dedicated hardware implementations, such as application specific integrated circuits, programmable logic arrays and other hardware devices, can be constructed to implement one or more of the methods described herein. Applications that include the apparatus and systems of various implementations can broadly include a variety of electronic and computer systems. One or more implementations described herein implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 800 is connected to the network 830. The network 830 defines one or more networks including wired or wireless networks, such as the network 104 described in FIG. 1. The wireless network can be a cellular telephone network, an 802.11, 802.18, 802.20, or WiMAX network. Further, such networks include a public network, such as the Internet, a private network, such as an intranet, or combinations thereof, and utilize a variety of networking protocols now available or later developed including, but not limited to TCP/IP based networking protocols. The network 830 can include wide area networks (WAN), such as the Internet, local area networks (LAN), campus area networks, metropolitan area networks, a direct connection such as through a Universal Serial Bus (USB) port, or any other networks that allow for data communication. The network 830 is configured to couple one computing device to another computing device to enable communication of data between the devices. The network 830 generally is enabled to employ any form of machine-readable media for communicating information from one device to another. The network 830 includes communication methods by which information may travel between computing devices. The network 830 can be divided into sub-networks. The sub-networks allow access to all of the other components connected thereto or the sub-networks restrict access between the components. The network 830 can be regarded as a public or private network connection and can include, for example, a virtual private network or an encryption or other security mechanism employed over the public Internet, or the like.

In accordance with various implementations of the present disclosure, the methods described herein are implemented by software programs executable by a computer system. Further, in one example, non-limited implementation, implementations can include distributed processing, component/object distributed processing, and parallel processing. Alternatively, virtual computer system processing can be constructed to implement one or more of the methods or functionalities as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (e.g., computer) system executing instructions (computer-readable code) stored in storage. It will also be understood that the disclosure is not limited to any particular implementation or programming technique and that the disclosure is implementable using any appropriate techniques for implementing the functionality described herein. The disclosure is not limited to any particular programming language or operating system.

It should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention can be practiced without these specific details. In other instances, well-known methods, structures, and techniques have not been shown in detail in order not to obscure an understanding of this description.

Thus, while there has been described what are believed to be the preferred embodiments of the invention, those skilled in the art will recognize that other and further modifications can be made thereto without departing from the spirit of the invention, and it is intended to claim all such changes and modifications as falling within the scope of the invention. For example, any formulas given above are merely representative of procedures that can be used. Functionality can be added or deleted from the block diagrams and operations are interchangeable among functional blocks. Steps can be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure further relates to the following aspects.

Example 1. A computer-implemented method for target message generation, the method comprising: inputting, by one or more processors, data associated with a user into a reinforcement learning model; generating, by the one or more processors and via the reinforcement learning model, a target message that satisfies a target response level of the user, wherein the reinforcement learning model is trained by: predicting a first message for a first type of user; determining, based on training data that includes respective associations between (a) a plurality of known messages and (b) a plurality of known labels indicative of a plurality of response levels associated with a second type of users for the plurality of known messages, that the first message will not satisfy the target response level; obtaining, using a predefined reward function, rewards based on the determination; and iteratively updating parameters of the reinforcement learning model until a second message is predicted for the first type of user that will satisfy the target response level to maximize the rewards; and transmitting, by the one or more processors, the target message to a computing device for presentation to the user.

Example 2. The computer-implemented method of example 1, wherein the data associated with the user is a latent feature representation for the user.

Example 3. The computer-implemented method of example 2, further comprising: receiving, by the one or more processors, a user data set including a plurality of features associated with a user; inputting, by one or more processors, the user data set into a pretrained machine learning model; and determining, by the one or more processors and via the pretrained machine learning model, the latent feature representation for the user.

Example 4. The computer-implemented method of example 3, wherein the pretrained machine learning model is pretrained by: receiving a plurality of data sets associated with a plurality of users, wherein at least a portion of each of the plurality of data sets is masked; and pretraining the pretrained machine learning model based on at least a portion of the plurality of data sets.

Example 5. The computer-implemented method of example 3, wherein the pretrained machine learning model includes an encoder-decoder architecture and an attention mechanism.

Example 6. The computer-implemented method of any of examples 1-5, wherein the reinforcement learning model includes a first neural network and a second neural network.

Example 7. The computer-implemented method of example 6, wherein generating the target message comprises: outputting, by the first neural network of the reinforcement learning model, a probability distribution over a plurality of message types that each message type will satisfy the target response level of the user based on the data associated with the user; selecting, as the target message, a message type, from the plurality of message types, having a highest probability distribution; providing the target message and the data associated with the user as input to the second neural network of the reinforcement learning model; and outputting, by the second neural network of the reinforcement learning model, a predicted response level of the user to the target message, wherein the predicted response level meets or exceeds a threshold response level indicative of the target message satisfying the target response level of the user.

Example 8. The computer-implemented method of any of examples 1-7, wherein generating the target message further comprises: generating, by the one or more processors and via the reinforcement learning model, customized content for the target message.

Example 9. The computer-implemented method of any of examples 1-8, wherein the user is a first user and the target message is a first target message, and the method further comprising: inputting, by the one or more processors, data associated with a second user into the reinforcement learning model; determining, by the one or more processors, that a second target message generated by the reinforcement learning model does not satisfy a target response level of the second user; in response to the determination, inputting, by the one or more processors, the data associated with the second user into a nearest neighbor model to identify a third user similar to the second user; and determining a third target message for presentation to the second user, the third target message being one of a plurality of message types that the third user has shown the target response level for.

Example 10. The computer-implemented method of any of examples 1-9, wherein the first type of user is a cold-start user.

Example 11. A system for target message generation, the system comprising: one or more processors; and at least one memory storing instructions that, when executed by the one or more processors, cause the one or more processors to perform operations including: inputting data associated with a user into a reinforcement learning model; generating, via the reinforcement learning model, a target message that satisfies a target response level of the user, wherein the reinforcement learning model is trained by: predicting a first message for a first type of user; determining, based on training data that includes respective associations between (a) a plurality of known messages and (b) a plurality of known labels indicative of a plurality of response levels associated with a second type of users for the plurality of known messages, that the first message will not satisfy the target response level; obtaining, using a predefined reward function, rewards based on the determination; and iteratively updating parameters of the reinforcement learning model until a second message is predicted for the first type of user that will satisfy the target response level to maximize the rewards; and transmitting the target message to a computing device for presentation to the user.

Example 12. The system of example 11, wherein the data associated with the user is a latent feature representation for the user.

Example 13. The system of example 12, the operations further including: receiving a user data set including a plurality of features associated with a user; inputting the user data set into a pretrained machine learning model; and determining, via the pretrained machine learning model, the latent feature representation for the user.

Example 14. The system of example 13, wherein the pretrained machine learning model is pretrained by: receiving a plurality of data sets associated with a plurality of users, wherein at least a portion of each of the plurality of data sets is masked; and pretraining the pretrained machine learning model based on at least a portion of the plurality of data sets.

Example 15. The system of example 13, wherein the pretrained machine learning model includes an encoder-decoder architecture and an attention mechanism.

Example 16. The system of any of examples 11-15, wherein the reinforcement learning model includes a first neural network and a second neural network, and generating the target message comprises: outputting, by the first neural network, a probability distribution over a plurality of message types that each message type will satisfy the target response level of the user based on the data associated with the user; selecting, as the target message, a message type, from the plurality of message types, having a highest probability distribution; providing the target message and the data associated with the user as input to the second neural network; and outputting, by the second neural network, a predicted response level of the user to the target message, wherein the predicted response level meets or exceeds a threshold response level indicative of the target message satisfying the target response level of the user.

Example 17. The system of any of examples 11-16, wherein generating the target message further comprises: generating, via the reinforcement learning model, customized content for the target message.

Example 18. The system of any of examples 11-17, wherein the user is a first user and the target message is a first target message, and the operations further including: inputting data associated with a second user into the reinforcement learning model; determining that a second target message generated by the reinforcement learning model does not satisfy a target response level of the second user; in response to the determination, inputting the data associated with the second user into a nearest neighbor model to identify a third user similar to the second user; and determining a third target message for presentation to the second user, the third target message being one of a plurality of message types that the third user has shown the target response level for.

Example 19. The system of any of examples 11-18, wherein the first type of user is a cold-start user.

Example 20. A non-transitory computer readable medium storing instructions which, when executed by one or more processors, cause the one or more processors to perform operations for target message generation, the operations comprising: inputting data associated with a user into a reinforcement learning model; generating, via the reinforcement learning model, a target message that satisfies a target response level of the user, wherein the reinforcement learning model is trained by: predicting a first message for a first type of user; determining, based on training data that includes respective associations between (a) a plurality of known messages and (b) a plurality of known labels indicative of a plurality of response levels associated with a second type of users for the plurality of known messages, that the first message will not satisfy the target response level; obtaining, using a predefined reward function, rewards based on the determination; and iteratively updating parameters of the reinforcement learning model until a second message is predicted for the first type of user that will satisfy the target response level to maximize the rewards; and transmitting the target message to a computing device for presentation to the user.

Example 21. The computer-implemented method of example 1, wherein the training of the reinforcement learning model is performed by the one or more processors.

Example 22. The computer-implemented method of example 1, wherein: the one or more processors are included in a first computing entity; and the training of the reinforcement learning model is performed by one or more processors included in a second computing entity.

Example 23. The computer-implemented method of example 4, wherein the pretraining of the pretrained machine learning model is performed by the one or more processors.

Example 24. The computer-implemented method of example 4, wherein: the one or more processors are included in a first computing entity; and the pretraining of the pretrained machine learning model is performed by one or more processors included in a second computing entity.

What is claimed is:

1. A computer-implemented method for target message generation, the method comprising:
inputting, by one or more processors, data associated with a user into a reinforcement learning model;
generating, by the one or more processors and via the reinforcement learning model, a target message that satisfies a target response level of the user, wherein the reinforcement learning model is trained by:
predicting a first message for a first type of user;
determining, based on training data that includes respective associations between (a) a plurality of known messages and (b) a plurality of known labels indicative of a plurality of response levels associated with a second type of users for the plurality of known messages, that the first message will not satisfy the target response level;
obtaining, using a predefined reward function, rewards based on the determination; and
iteratively updating parameters of the reinforcement learning model until a second message is predicted for the first type of user that will satisfy the target response level to maximize the rewards; and
transmitting, by the one or more processors, the target message to a computing device for presentation to the user.

2. The computer-implemented method of claim 1, wherein the data associated with the user is a latent feature representation for the user.

3. The computer-implemented method of claim 2, further comprising:
receiving, by the one or more processors, a user data set including a plurality of features associated with a user;
inputting, by one or more processors, the user data set into a pretrained machine learning model; and
determining, by the one or more processors and via the pretrained machine learning model, the latent feature representation for the user.

4. The computer-implemented method of claim 3, wherein the pretrained machine learning model is pretrained by:
receiving a plurality of data sets associated with a plurality of users, wherein at least a portion of each of the plurality of data sets is masked; and
pretraining the pretrained machine learning model based on at least a portion of the plurality of data sets.

5. The computer-implemented method of claim 3, wherein the pretrained machine learning model includes an encoder-decoder architecture and an attention mechanism.

6. The computer-implemented method of claim 1, wherein the reinforcement learning model includes a first neural network and a second neural network.

7. The computer-implemented method of claim 6, wherein generating the target message comprises:
outputting, by the first neural network of the reinforcement learning model, a probability distribution over a plurality of message types that each message type will satisfy the target response level of the user based on the data associated with the user;
selecting, as the target message, a message type, from the plurality of message types, having a highest probability distribution;
providing the target message and the data associated with the user as input to the second neural network of the reinforcement learning model; and
outputting, by the second neural network of the reinforcement learning model, a predicted response level of the user to the target message, wherein the predicted response level meets or exceeds a threshold response level indicative of the target message satisfying the target response level of the user.

8. The computer-implemented method of claim 1, wherein generating the target message further comprises:
generating, by the one or more processors and via the reinforcement learning model, customized content for the target message.

9. The computer-implemented method of claim 1, wherein the user is a first user and the target message is a first target message, and the method further comprising:
inputting, by the one or more processors, data associated with a second user into the reinforcement learning model;
determining, by the one or more processors, that a second target message generated by the reinforcement learning model does not satisfy a target response level of the second user;
in response to the determination, inputting, by the one or more processors, the data associated with the second user into a nearest neighbor model to identify a third user similar to the second user; and
determining a third target message for presentation to the second user, the third target message being one of a plurality of message types that the third user has shown the target response level for.

10. The computer-implemented method of claim 1, wherein the first type of user is a cold-start user.

11. A system for target message generation, the system comprising:
one or more processors; and
at least one memory storing instructions that, when executed by the one or more processors, cause the one or more processors to perform operations including:
inputting data associated with a user into a reinforcement learning model;
generating, via the reinforcement learning model, a target message that satisfies a target response level of the user, wherein the reinforcement learning model is trained by:
predicting a first message for a first type of user;
determining, based on training data that includes respective associations between (a) a plurality of known messages and (b) a plurality of known labels indicative of a plurality of response levels associated with a second type of users for the plurality of known messages, that the first message will not satisfy the target response level;
obtaining, using a predefined reward function, rewards based on the determination; and
iteratively updating parameters of the reinforcement learning model until a second message is predicted for the first type of user that will satisfy the target response level to maximize the rewards; and
transmitting the target message to a computing device for presentation to the user.

12. The system of claim 11, wherein the data associated with the user is a latent feature representation for the user.

13. The system of claim 12, the operations further including:
receiving a user data set including a plurality of features associated with a user;
inputting the user data set into a pretrained machine learning model; and
determining, via the pretrained machine learning model, the latent feature representation for the user.

14. The system of claim 13, wherein the pretrained machine learning model is pretrained by:
receiving a plurality of data sets associated with a plurality of users, wherein at least a portion of each of the plurality of data sets is masked; and
pretraining the pretrained machine learning model based on at least a portion of the plurality of data sets.

15. The system of claim 13, wherein the pretrained machine learning model includes an encoder-decoder architecture and an attention mechanism.

16. The system of claim 11, wherein the reinforcement learning model includes a first neural network and a second neural network, and generating the target message comprises:
outputting, by the first neural network, a probability distribution over a plurality of message types that each message type will satisfy the target response level of the user based on the data associated with the user;
selecting, as the target message, a message type, from the plurality of message types, having a highest probability distribution;
providing the target message and the data associated with the user as input to the second neural network; and
outputting, by the second neural network, a predicted response level of the user to the target message, wherein the predicted response level meets or exceeds a threshold response level indicative of the target message satisfying the target response level of the user.

17. The system of claim 11, wherein generating the target message further comprises:
generating, via the reinforcement learning model, customized content for the target message.

18. The system of claim 11, wherein the user is a first user and the target message is a first target message, and the operations further including:
inputting data associated with a second user into the reinforcement learning model;
determining that a second target message generated by the reinforcement learning model does not satisfy a target response level of the second user;
in response to the determination, inputting the data associated with the second user into a nearest neighbor model to identify a third user similar to the second user; and
determining a third target message for presentation to the second user, the third target message being one of a plurality of message types that the third user has shown the target response level for.

19. The system of claim 11, wherein the first type of user is a cold-start user.

20. A non-transitory computer readable medium storing instructions which, when executed by one or more processors, cause the one or more processors to perform operations for target message generation, the operations comprising:
inputting data associated with a user into a reinforcement learning model;
generating, via the reinforcement learning model, a target message that satisfies a target response level of the user, wherein the reinforcement learning model is trained by:
predicting a first message for a first type of user;
determining, based on training data that includes respective associations between (a) a plurality of known messages and (b) a plurality of known labels indicative of a plurality of response levels associated with a second type of users for the plurality of known messages, that the first message will not satisfy the target response level;
obtaining, using a predefined reward function, rewards based on the determination; and
iteratively updating parameters of the reinforcement learning model until a second message is predicted for the first type of user that will satisfy the target response level to maximize the rewards; and
transmitting the target message to a computing device for presentation to the user.
